(19) United States
(12) Patent Application Publication
(10) Pub. No.: US 2008/0120714 A1
(43) Pub. Date: May 22, 2008

(54) METHOD FOR AUTHENTICATING NOMADIC USER DOMAINS AND NODES THEREFOR

(75) Inventors: Sylvain Monette, Stockholm (SE); Mathieu Giguere, Vaudreuil-sur-le-Lac (CA); Martin Julien, Laval (CA); Benoit Tremblay, Laval (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/561,447

(22) Filed: Nov. 20, 2006

(51) Int. Cl. H04L 9/00

(52) U.S. Cl. 726/11

(57) ABSTRACT

The present invention provides a method and nodes for authenticating nomadic users accessing service providers. An access edge node authenticates nomadic users when service requests are received therefrom. The access edge node hosts a plurality of service agents, where each service agent comprises transport parameters for access to one of the service providers. Upon receipt at the access edge node of a service request message identifying a service provider and a nomadic user, an identity of the nomadic user is authenticated and verification is made that a service agent corresponding to the identified service provider exists. If both the authentication and the verification are positive, an authenticated service binding is created, connecting the nomadic user, the service provider and the transport parameters. Then, an access node providing access to the nomadic user for which the service request message was received is informed of the authenticated service binding.

### BACKGROUND OF THE INVENTION

1. Field of the Invention

The present invention relates to methods and nodes for authenticating nomadic user domains getting access to service provider domains.

2. Description of the Related Art

Recent years have seen the explosion of Internet Protocol (IP) networks. Initially developed to allow universities and researchers to communicate and cooperate in research projects, they have grown into networks offered at a mass-market level. Nowadays, it is normal for households to have a connection to an IP network to surf the world-wide-web, play interactive games, carry Voice over IP, download documents and softwares, make electronic business transactions, etc.

Reference is now made to FIG. 1, which represents a prior art example of an IP network 100. Typically, an IP network is composed of an access domain 115, network service provider domains 140 and application service provider domains 150. The access domain 115 includes Access Nodes 120 and an access network 130, which may itself be an IP sub-network. The access nodes 120 are access providers, which can offer access to the IP network 100 to user domains 110. The user domains 110 include for example user devices (such as computers, mobile phones, personal digital assistants, etc.), Local Area Networks (LANs) and Wireless-LANs (W-LANs). The user domains communicate with the access nodes over various possible technologies. Amongst those technologies can be found dial-up connections and Asymmetric Digital Subscriber Line connections over telephone lines, cable modems connecting over television cable networks, or wireless communications. The access network 130 is composed of a group of independent switches and routers, which task is to switch/route incoming data traffic based on a destination address embedded therein. As for the network service provider domains 140, they may correspond for example to Voice over IP services, while the application service provider domains 150 may correspond to electronic banking and electronic business transactions.

Though FIG. 1 depicts three user domains, two Access Nodes, two service provider domains and two application service domains, IP networks 100 typically include several thousands of user domains, tenths of Access Nodes, hundreds of network service provider domains and application service provider domains. As to the access network 130, it is common to encounter networks including hundreds of switches and/or routers. It is thus understood that FIG. 1 depicts a highly simplified IP network 100 for clarity purposes.

The initial principle at the basis of IP networks is to rely on routers, which perform as few and as little operations as possible before routing incoming data traffic towards their final destination. In practice, such a principle results in “best effort” networks that result in a trade-off between quality of service and quantity of data traffic. An increased Quality of Service (QoS), for the same number of routers results in a lower quantity of data traffic being transported on those routers. Hence, IP networks have not been designed bearing in mind higher level of QoS. For those reasons, IP networks have difficulty supporting data traffic for network service provider domains and application service provider domains that require a higher QoS, and especially more so with the current explosion of user domains.

In conventional networks such as shown on FIG. 1, a relationship between user domains 110 and access nodes 120 is oftentimes taken for granted. For example, when the user domain 110 is embodied in a cable modem or in a digital subscriber line (DSL) end-terminal, located within home premises of a subscriber and connected to the access node 120 by a fixed wire or cable under the control of an operator of the access node 120, authentication of the user domain 110 by the access node 120 is a non-issue. In such cases, the user domain 110 is associated with a specific port on the access node 120. Any traffic arriving at the access node 120 on the specific port is assumed to be from a legitimate user domain 110. Hence the relationship between the fixed user domain 110 and the access node 120 may be called port-based authentication. But when the user domain 110 consists of a nomadic device capable of being moved from one location to another and capable of connecting by wire or wirelessly to different access nodes 120, authentication of the user domain 110 becomes an important issue because the user domain 110 may associate with any port of more than one access node 120. In many instances, when user domains 110 connect to a variety of access nodes 120 by use of any one of a variety of access technologies, strong authentication means may not be present. Even when the user domain 110 is a Global System for Mobile (GSM) terminal and the access node 120 is embodied in a GSM cellular network, strong authentication means exist between the cellular network and the terminal. However, in the case of GSM access, information about the strong authentication means present within the GSM cellular network may not be passed in IP signalling through the access domain 115 towards the network service provider domains 140 and towards the application service provider domains 150. From the standpoint of the service provider domains 140 and 150, the issue of authentication of the user domains 110 remains.

There is currently no known secure, end-to-end solution to the problems associated with the explosion of the number of nomadic user devices and of service providers offering services on IP networks.

Accordingly, it should be readily appreciated that in order to overcome the deficiencies and shortcomings of the existing solutions, it would be advantageous to have a method and nodes for efficiently and securely allowing thousands of network service provider domains and application service provider domains to communicate over an access network with nomadic user devices. It would also be another advantage to have a method and nodes that allow for a coordinated usage of the access network while providing various levels of quality of service. The present invention provides such a method and nodes.

### SUMMARY OF THE INVENTION

The present invention efficiently allows thousands of network service provider domains and application service provider domains to communicate over an access domain with nomadic user domains, following authentication thereof, applying a set of transport parameters to data traffic. The method and nodes for securely carrying data traffic of the present invention rely on a coordinated usage of the access domain and the concept of authenticated service bindings for providing various levels of quality of service.

For doing so, the present invention is concretized, in one aspect, in an access edge node for authenticating nomadic user domains upon access to service provider domains. The access edge node is located in an access domain carrying data traffic between the nomadic user domains and the service provider domains. The access edge node comprises a service agent, a service binding unit, an input/output unit, an authentication unit and a controlling unit. The service agent unit hosts service agents, each of which comprises an identity corresponding to one of the service provider domains, and transport parameters related to the services offered by the service provider domain. The service bindings unit hosts service bindings that include the identity and the transport parameters of one of the service agents, and an identity of one nomadic user domain. The input/output unit allows communication with the service provider domains, with the access domain and with access nodes that provide the nomadic user domains access to the access domain. Notably, the input/output unit sends information to the access nodes about the serving bindings. The input/output unit also receives service request messages, each service request message comprising an identity of a selected service provider domain and an identity of a given nomadic user domain. The authentication unit is used to validate the identity of a nomadic user domain comprised in a service request message received at the input/output unit. The controlling unit, upon receipt of a service request message comprising a valid identity of the nomadic user domain, determines whether one of the service agents corresponds to the selected service provider domain and, if so, creates an authenticated service binding in the service bindings unit. The controlling unit also orders the input/output unit to inform an access node serving the given nomadic user domain of the content of the authenticated service binding. Finally, the controlling unit applies transport parameters of the authenticated service binding for transporting data traffic between the given nomadic user domain and the selected service provider domain.

In another aspect, the invention relates to a method for authenticating a nomadic user domain upon access to a selected service provider domain over an access domain. The method provides a plurality of service agents in an access edge node, each of the service agents corresponding to one service provider domain, each of the service agents comprising transport parameters. The access edge node receives a service request message identifying the selected service provider domain and comprising an identity of the nomadic user domain. The identity of the nomadic user domain is authenticated. Provided the identity is valid, it is determined whether one of the provided service agents corresponds to the selected service provider domain. Provided that the above verifications are successful, the access edge node then creates an authenticated service binding for the received service request message. The service binding contains an identity of the service agent corresponding to the selected service provider domain, the identity of the nomadic user domain, and transport parameters comprised in the service agent corresponding to the selected service provider domain. A copy of the service binding content is sent towards an access node responsible for providing access to the nomadic user domain. Finally, the transport parameters of the service binding are used at the access edge node and at the access node for transporting data traffic between the identified nomadic user domain and the selected service provider domain.

In a further aspect, the present invention relates to an access node for authenticating nomadic user domains upon access to service provider domains. The access node is located in an access domain carrying data traffic between the nomadic user domains and the service provider domains. The access node comprises an input/output device for sending requests for identification towards the nomadic user domains, for receiving identities from the nomadic user domains, for forwarding the identities received from the nomadic user domains over the access domain, for receiving service binding information, and for receiving and forwarding data traffic. A service binding table is used in the access node for storing service binding information for many service bindings, each service binding including an identification of a corresponding service provider domain, an authenticated identity of a nomadic user domain, and transport parameters. In addition, the service binding table also stores for each service binding a user domain connection status. A timing units sends periodic time out signals to a controlling unit which, in turn, instructs the input/output device to send the requests for identification. When the input/output device forwards an identity from a given nomadic user domain to the controlling unit, the controlling unit requests the service binding table to store a user domain connection status in the corresponding service binding. Then, upon receipt of data traffic from the given nomadic user domain at the input/output device, the controlling unit checks the user domain connection status and, if it indicates that the nomadic user domain is connected, informs the input/output device to forward the received data traffic over the access domain in accordance with the transport parameters of the corresponding service binding.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a prior art example of an IP network;

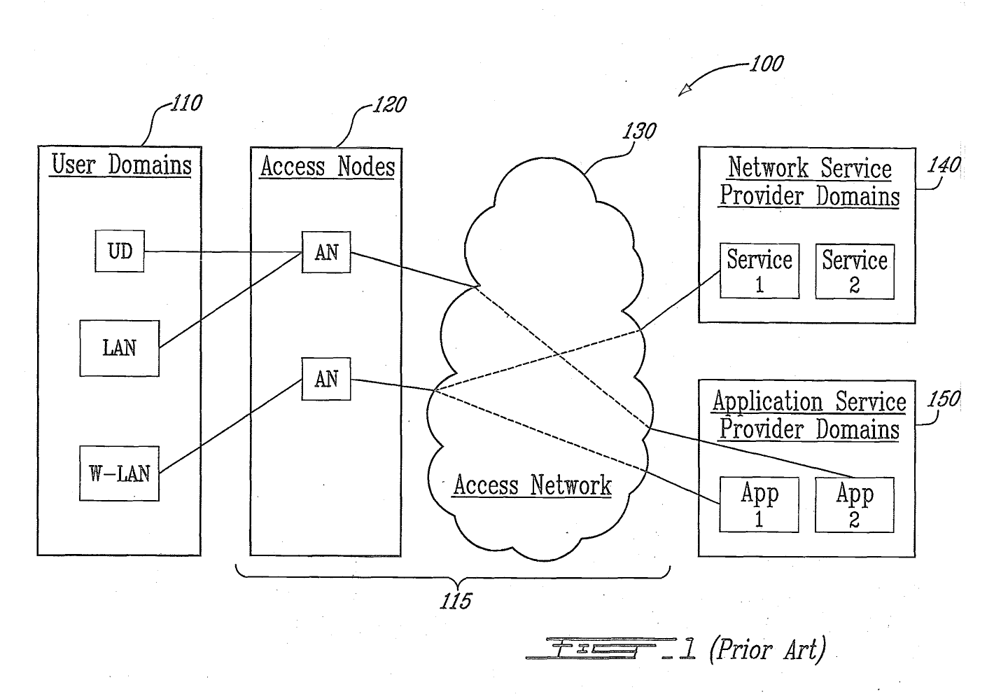

FIG. 2 is a schematic exemplifying a network in which the present invention has been incorporated;

FIG. 3 is a simplified flowchart of a method for authenticating a nomadic user domain in accordance with the present invention;

FIG. 4 is an exemplary diagram showing signaling messages exchanged between various nodes in accordance with the present invention;

FIG. 5 is a schematic representation of an access edge node in accordance with the teachings of the present invention;

FIG. 6a is an exemplary tabular representation of the content of a service agents management and control unit in accordance with the present invention;

FIG. 6b is an exemplary tabular representation of the content of a service bindings hosting unit in accordance with the teachings of the present invention; and

FIG. 7 is a schematic representation of an access node in accordance with the teachings of the present invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a method and nodes for authenticating nomadic user domains in communication over an access domain with service provider domains. An access node and an access edge node are used within the access domain, between the nomadic user domains and the service provider domains for carrying data traffic exchanged therebetween. The access node provides the nomadic user domains with access to the access domain. The access edge node aggregates data traffic exchanged between a very large number of nomadic user domains and a lesser number of service provider domains. The access edge node includes a service agent unit, which manages and controls service agents. Each of the service agents corresponds to one of the service provider domains, a distinct service agent preferably corresponding to each of distinct types of service offered by a same service provider domain. Each service agent further comprises transport parameters intended for guaranteeing a desired quality of service (QoS). Whenever a nomadic user domain wishes to communicate with a selected one of the service provider domains, a service request message is sent through the access node towards the access edge node. The service request comprises an authenticatable identity of the nomadic user domain. The message further includes information identifying one of the service provider domains and, preferably, a request for a service type offered by the identified service provider domain. The access edge node determines whether one of the service agents corresponds to the service provider domain and, if applicable, to the service type requested in the service request message. The access edge node further verifies the authenticity of the nomadic user domain identity. If the nomadic user domain is valid and if one of the service agents corresponds to the service type and to the service provider domain identified in the service request message, the access edge node creates an authenticated service binding for the received service request message. The service binding comprises an identity one of the service agents, the nomadic user domain identity, and transport parameters from the service agent. Because the nomadic user domain identity stored in the service binding has been authenticated, the service binding itself is authenticated as well. Then, the access node is informed of the service binding content. Data traffic to the service request message is then carried over the access domain in accordance with the transport parameters contained in the service binding. Thereafter, the access edge node and the access node may also use the authenticated service binding to validate that upstream data is received from the legitimate nomadic user domain and that downstream data will indeed be sent to the proper nomadic user domain.

The expression “data traffic” is used throughout the present specification and includes messages and information transferred over a data network.

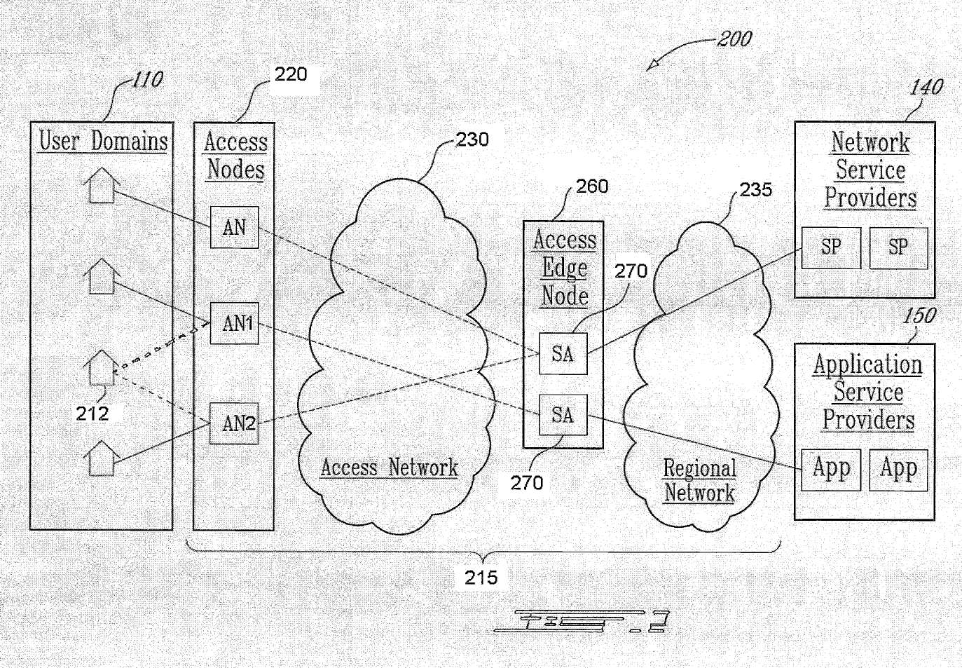

To understand the present invention and its inventive mechanisms, reference is now made to FIG. 2, which is a schematic exemplifying a network 200 in which the present invention has been incorporated. The schematic representation of the network 200 has been simplified for clarity purposes, and the various elements depicted have been grouped by similar functions rather than graphically representing geographical network entities. However, each group of similar functions would typically correspond to a multitude of physical network entities performing those specific functions, geographically scattered throughout the network 200. The schematic representation of the network 200 includes user domains 110, of which some are nomadic user domains 212, an access domain 215 (including: access nodes 220, an access network 230, an access edge node 260 and a regional network 235), network service providers 140, and application service providers 150. The access nodes 220, the access network 230, the access edge node 260, the regional network 235, the network service providers 140 and the application service providers 150 may all be capable of serving both user domains 110 that have fixed connections to given access nodes 220, and nomadic user domains 212 capable of moving about from one access node 220 to the next. In the foregoing description of the various nodes of the present invention, while focus is given on the specific features aimed at supporting nomadic user domains 212, it should be understood that those nodes may at the same time be capable of supporting user domains 110 that are not nomadic. An exhaustive description and examples for each of those elements will be provided in the following paragraphs, with continued reference to FIG. 2.

Turning now to the access domain 215, it is possible to summarize its function as a means to provide end-to-end access between the user domains 110 and the network service providers 140 and application service providers 150. The access domain includes the access nodes 220, the access network 230, the regional network 235 and the access edge node 260. Thus, the access domain 215 is not an entity per se; it is rather a group of components, which when interconnected together either directly or indirectly, act as a domain for providing access, hence its name “access domain”. It should thus be understood that the current representation of the access domain 215 including only one access node 220, one access network 230, one access edge node 260 and one regional network 235 does not mean that only one entity of each type is found in the access domain, but rather that for sake of clarity only one such entity is represented. The following paragraphs explain in greater details the various components of the access domain.

The access nodes 220, which may also include access gateways (not shown), represent the first component of the access domain 215. The access nodes 220 typically refer to access providers, which allow user domains 110 accesses to the access network 230, upon, for example, subscription or pay-per-usage basis. Such access can be made possible using various media and technologies. Even though only three access nodes have been depicted, it should be noted that the network 200 potentially includes hundreds or thousands of access nodes.

The access domain also includes the access network 230 and the regional network 235 which will be discussed together. The primary function of the access network 230 and the regional network 235 is to provide end-to-end, and independent transport between the access nodes 220 and the network service providers 140 and the application service providers 150. The access network 230 and regional network 235 are networks capable of tasks such as: switching and routing downstream and upstream data traffic. The access network 230 is preferably capable of using Ethernet, or other similar protocols, which correspond to the Layer 2 of the OSI model, but is not limited thereto. It could advantageously be capable of supporting IPv4 and/or IPv6. The regional network 235 preferably supports Ethernet and/or IP and MultiProtocol Label Switching, and possibly other Layer 3 capable protocols. Furthermore, it should be noted that the access network 230 and the regional network 235 could be operated and/or managed by a single operator or by many different operators.

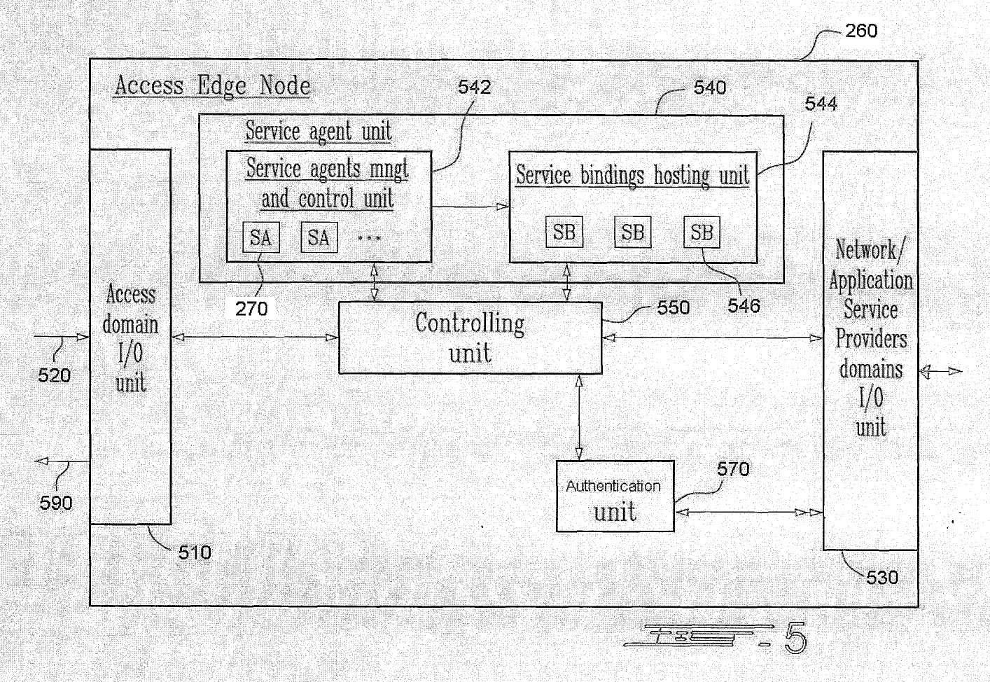

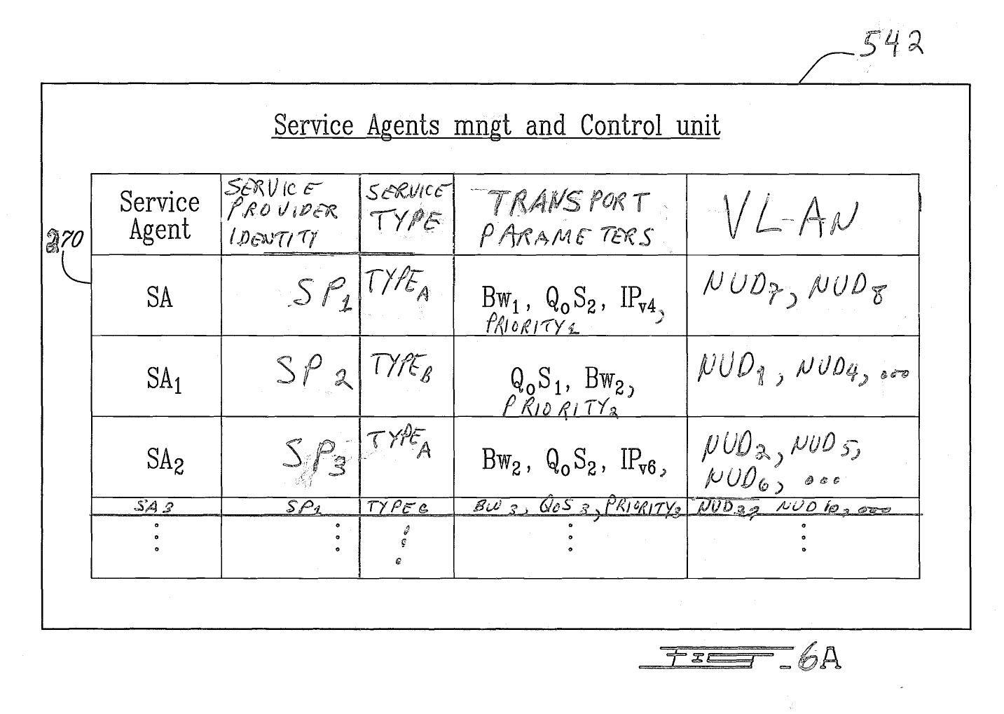

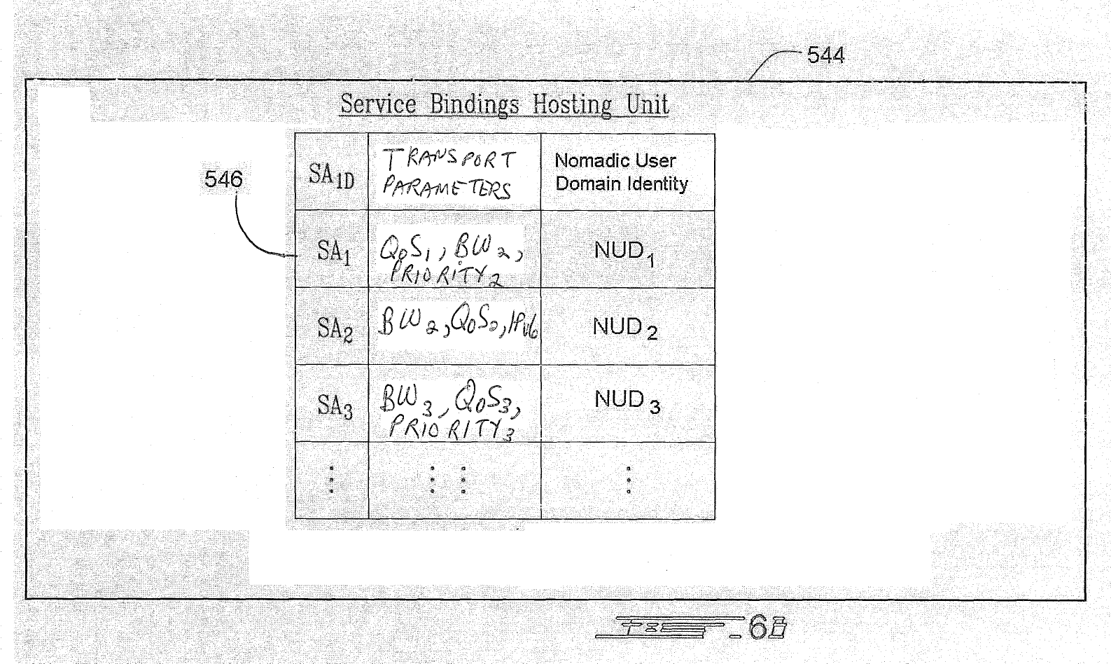

It is through a tight coupling of their traffic-engineering capabilities through the access edge node 260, that the access network 230 and the regional network 235 can provide end-to-end Quality of Service (QoS). The role of the access edge node 260 is the creation, management and hosting of service agents 270 and service bindings (not shown in FIG. 2, but depicted on FIG. 5). Each of the service agents 270 corresponds to a service offered by one of the service provider domains (140 or 150), and manages and controls therefor a Virtual Local Area Network (VLAN) over the access network 230. The VLAN extends between the access edge node 260 and the access nodes 220. Conceptually speaking, provisioning of service agents corresponds to creating VLANs for the service provider domains 140 or 150, distinct VLANs being preferably defined for distinct service types offered by a same service provider 140 or 150. The creation of a service binding corresponds to adding a nomadic user domain 212 to a VLAN for a service type the nomadic user domain is accessing on a service provider 140 or 150. Within a given VLAN, payload from or to any number of users receiving a same type of service from the same service provider is exchanged between the access nodes that the users are accessing and the access edge node, in both directions, according to transport parameters defined by the service agent that relates to that service provider, for which QoS parameters are guaranteed. The expression “service binding” refers to a binding between the user domain 110 and one of the network service provider domains 140 or one of the application service provider domains 150. The access edge node and the concepts of service agents and service bindings will be described in further detail in the description referring to FIGS. 5, 6a and 6b.

Turning now to the user domains 110, the latter rely on the access domain 215 for handling end-to-end communication with the network service providers 140 and the application service providers 150. It should be noted that in the present description, use of the word “domain” refers to one or multiple network elements sharing similar functional features. Thus, in the context of the present invention, the expression “user domains” may refer to independent computers, local networks of computers connected through a router either physically or wirelessly, wireless phones, Personal Digital Assistants (PDAs), and all other devices that are capable of data communication over a data network such as network 200. Additionally, the “user domain” is intended to also support multiple simultaneous data traffic sessions performed with a multitude of devices, through one single user port. For example, a user could concurrently access different applications and network services such as Internet access, video conferencing, and television programs with one or multiple devices through a user domain located local area network, or one single user port referred to herein as “user domain”.

An increasing number of user domains 110 are nomadic user domains 212 capable of being moved from one location to another and capable of connecting by wire or wirelessly to different access nodes 220. Nomadic user domains may include for example user devices (such as computers, mobile phones, personal digital assistants, etc.), Local Area Networks (LANs) and Wireless-LANs (W-LANs) or groups of such devices. As for any other user domains, the nomadic user domains may communicate with the access nodes over various possible technologies. Amongst those technologies can be found dial-up connections and Asymmetric Digital Subscriber Line connections over telephone lines, cable modems connecting over television cable networks, or wireless communications. User domains are deemed nomadic when they can connect to various access nodes at different times, possibly in various locations. In some cases, a nomadic user domain may comprise more than one access technology for connecting to access nodes. Nomadic user domains comprise means to identify themselves to access networks and to service providers. For example, a subscriber identity module (SIM) card, such as those used in Global System for Mobile (GSM) wireless technology, may be used by a nomadic user device. The SIM card may be removed from a GSM terminal and inserted into a distinct terminal, thereby carrying nomadic user domain identity and other information into that terminal. In FIG. 2, one such nomadic user domain 212 is shown connecting either to access node AN1 or to access node AN2. Nomadic user domains 212 bring about a problem that is not present in fixed user domains 110. Fixed user domains 110 are connected to given access nodes 120 or 220 on ports that are specific to each user domain 110, by use of connections that are controlled by the access nodes 120 or 220. In contrast, there may not be any strong authentication means between the nomadic user domains 212 and the access nodes 220 that they are accessing.

The network service providers 140 refer to entities that use the access domain 215 to provide connectivity to other IP networks, and to offer and deliver specific applications. The application service providers 150 use the access domain 215 to offer and deliver application to end-users of the user domains 110. Examples of such applications include gaming, video on demand, videoconferencing, and many other possible applications. It should be noted that in the foregoing description, the expression “service providers” and “service providers domains” will be alternatively used to represent concurrently both network service providers 140 and application service providers 150, and the expression “service provider” represents one of the network service providers 140 or application service providers 150.

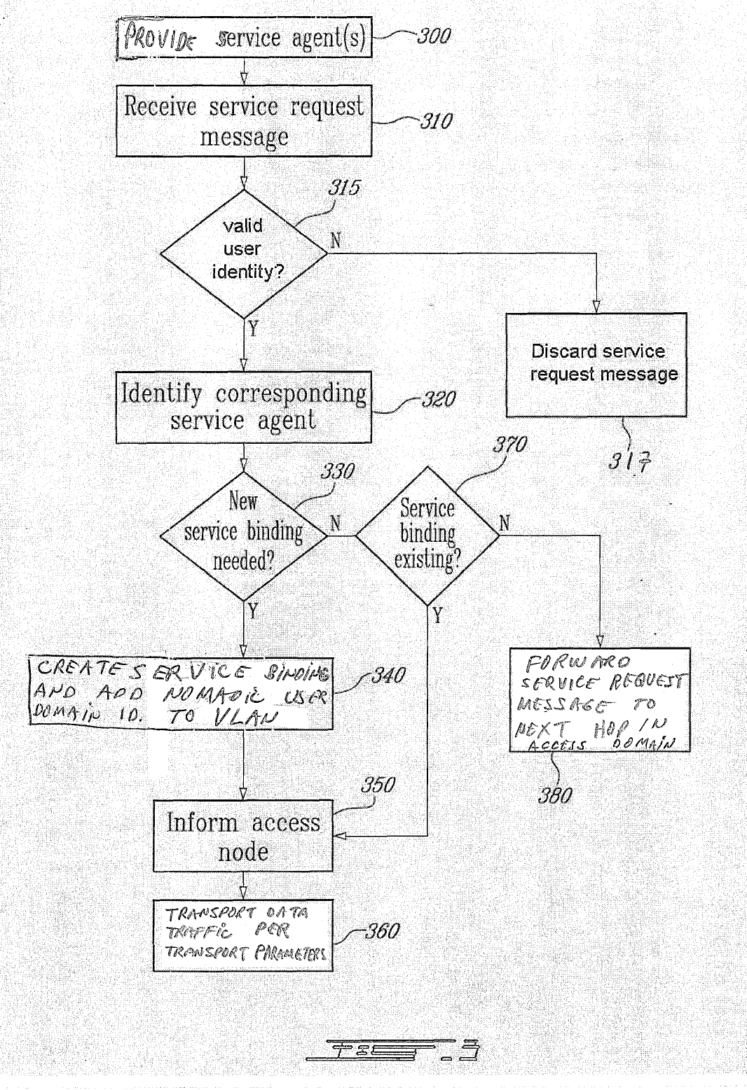

Reference is now made to FIG. 3 that represents a simplified flowchart of a method for authenticating a nomadic user domain in accordance with the present invention. The present method allows secure transport of data traffic between a plurality of network service providers 140 and application service providers 150, and nomadic user domains 212, over the access domain 215. The method may optionally start with a step 300 for establishing or otherwise providing a plurality of service agents over the access domain 215. However, it should be noted that, at step 300, establishing a plurality of new service agents may only be performed when an access edge node 260 is introduced in the access domain 215, and that a new service agent is established whenever a new network service provider 140 or application service provider 150, or a new service for an existing service provider 140 or 150 is added to the network 200. Also at step 300, the provision of the plurality of service agents also comprises setting up, in each service agent, of a VLAN corresponding to a service offered by the service provider domain 140 or 150 related to the service agent. Afterwards, the method starts at step 310 with the receiving of a service request message at the access edge node 260. The service request message identifies one of the service providers, one of the nomadic user domains and may preferably identify a requested type of service. However, the service type may not always be required, for example, when the service provider identified in the service request message only offers one type of service, or offers distinct service types with comparable transport characteristics. Specifically, a secure identity of the nomadic user domain is included in the service request message. The service request message may have been generated for example through accessing by the identified nomadic user domain of a web page of the identified service provider. Responsive to the service request message, a step 315 of authenticating, by the access edge node 260, the secure identity of the nomadic user domain follows. If the authentication verification fails, the service request message is simply discarded at step 317. Otherwise, the method pursues with a step 320 for determining whether one of the established service agents corresponds to the identified service type and service provider 140 or 150. If no service agent matches the identified service type and service provider 140 or 150, the service request is handled as in the prior art, for example by forwarding the request towards a next hop or router, without use of any specific transport parameter. If a corresponding service agent is identified, the method has a step 330 for determining whether creation of a service binding is needed. If the determining step 330 is positive, the method pursues with a step 340 of creating a service binding for the received service request message, the created service binding being an authenticated service binding comprising the authenticated nomadic user domain identity, the step 340 also comprising adding the identity of the nomadic user domain to the VLAN within the service agent. The method pursues with step 350 of informing an access node 220 responsible for providing access to the nomadic user domain identified in the service request message of the creation of the service binding. The access node 220 is thus informed that data traffic received from the nomadic user domain identified in the service request message and addressed to the identified service provider is to be carried over the access domain in accordance with the created service binding and with the transport parameters comprised therein. The method continues with step 360 which consists of transporting data traffic over the access domain 215, received at the access node or the access edge node for the identified nomadic user domain and service provider, in accordance with the transport parameters defined by the created service binding. In the event in step 330 that it is determined that creation of a service binding is not needed, the method further proceeds with a step 370 for determining whether a service binding already exists for the received service request message. A service binding may already exist for example in a case where a first and then a second query are made from a given nomadic user domain, for service from a same service provider. For example, the nomadic user domain may request to concurrently transfer two music files from a same music service provider, thereby reusing the same service binding. In the event that the outcome of the determination step 370 is that a service binding already exists, the method pursues with step 350 of informing the access node 220 of the existing service binding. Alternatively, if the outcome of the determination step 370 is negative, the method continues at step 380 where the service request is forwarded towards the next hop or router in the access domain 215, without further treatment in the access edge node 260.

As previously mentioned, a service binding comprises transport parameters. Those parameters define a transport relationship. That transport relationship is established between one of the nomadic user domains and one of the service providers, and directly impacts the serving access node 220 and one of the serving agents 270 of the access edge node 260. Thus, each service binding guarantees delivery of the corresponding service, with the specified integrity and QoS, for a specific nomadic user domain receiving service from a specific provider. Service bindings are created, managed and hosted in the access edge node, and exist in combination with the service agents 270.

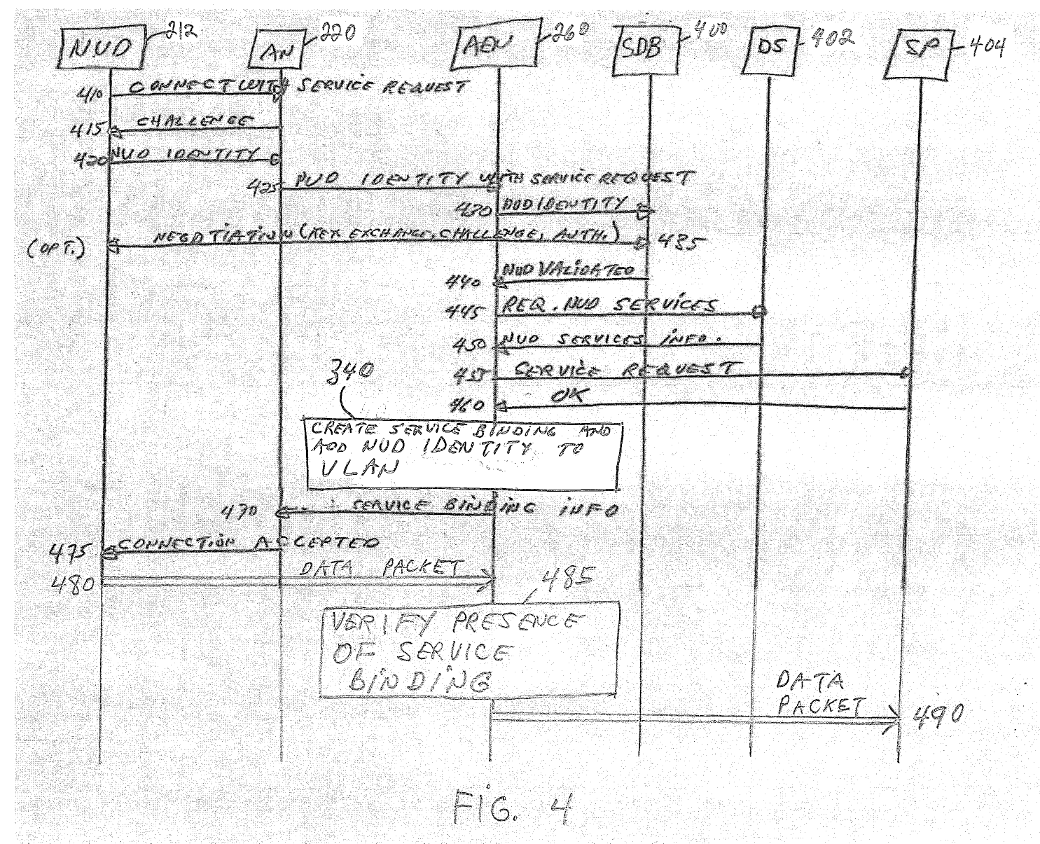

Other aspects of the method introduced in the description of FIG. 3 are now described with reference to FIG. 4, which is an exemplary diagram showing signaling messages exchanged between various nodes in accordance with the present invention. Nodes involved in the diagram comprise a nomadic user domain (NUD) 212, an access node (AN) 220, an access edge node (AEN) 260, a subscription database (SDB) 400, a directory service (DS) 402, and a service provider (SP) 404. The AN 220 and the AEN 260 are comprised in an access domain 215 as earlier shown in the description of FIG. 2. The SDB 400 may for example be a home location register (HLR) or an authentication, authorization, and accounting (AAA) server, as are well-known in cellular telephony, or an identity provider (IDP) as defined in Telecommunications and Internet converged Services and Protocols for Advanced Networking (TISPAN) standards. The DS 402 may be embodied, for example within an HLR or in any other database for services allocated to users of NUDs 212. The SP 404 of FIG. 4 may be a network service provider 140 or an application service provider 150. Some of the nodes listed hereinabove may only be present in certain optional aspects and not in other aspects of the present invention, but are shown in FIG. 4 to better illustrate many possible exemplary uses of the method for authenticating nomadic user domains.

The signaling sequence starts at step 410 when the NUD 212 sends a signal towards the AN 220, requesting to set up a connection, the request comprising a request for service with the SP 404. The signal of step 410 may comprise an identity of the NUD 212. If so, the sequence continues at step 425. If no identity of the NUD 212 is included in the connection signal, the AN 220 sends a challenge message towards the NUD 212 at step 415. The NUD 212 replies at 420 with its identity. At step 425, the AN 220 forwards the service request towards the AEN 260, the request comprising the identity of the NUD 212. If the AEN 260 already possesses necessary information to authenticate the identity of the NUD 212, it validates the service request upon receipt at step 425 in which case, if the identity is found to be invalid, the service request is ignored and the process is terminated. If the AEN 260 positively authenticates the NUD 212 identity at step 425, the process may continue at optional steps 445 or 455, or directly at step 340. Alternatively, the AEN 260 may send the NUD 212 identity towards the SDB 400 for authentication at step 430. For an enhanced level of security, the SDB 400 may, at step 435, initiate a negotiation sequence with the NUD 212, the negotiation sequence comprising key exchanges, challenges, or other authentication means as are well known in the art. At step 440, the SDB 400 informs the AEN 260 of an identity verification response. If the response indicates that the identity of the NUD 212 has not been validated, the service request is ignored and the process terminates. In some cases when the NUD 212 identity has been validated, the SDB 400 also includes in the identity verification response of step 440 a list of services that the user of the NUD 212 is subscribed to. Alternatively, the AEN 260 may query the DS 402 for such a list of services, by sending a request at step 445, which is replied to at step 450 with the complete list of services for the NUD 212. However, for many simple service types, no specific service subscription may be required so steps 445-450 may be omitted. At this point, it may be advantageous for the AEN 260 to verify with the SP 404 that it has sufficient resources to accept the service request. The service request is thus optionally forwarded to the SP 404 at step 455, which enables the SP 404 to verify its resources and also to prepare for serving the request. The SP 404 replies at step 460 with a positive indication. At step 340, the step having been described hereinabove in relation to FIG. 3, the AEN 260 sets up an authenticated service binding to identify a service agent of the AEN 260 which relates to the SP 404, authenticated NUD 212 identity, and access domain transport parameters, at the same time adding the NUD 212 to the VLAN of the service agent. A copy of the service binding information is sent towards the AN 220 at step 470 and, in turn, the AN 220 informs the NUD 212 that the connection is accepted at step 475. Once the service binding has been properly created at the AEN 260 and stored both in the AEN 260 and in the AN 220, data packets are exchanged between the NUD 212 and the SP 404. At step 480, a data packet originating from the NUD 212 arrives at the AEN 260. The AEN 260 validates the connection of the NUD 212 at step 485 by verifying that there is a service binding present for that NUD 212. Provided that this verification is positive, the AEN 260 forwards the data packet at step 490. Of course, those skilled in the art will readily observe that similar actions aimed at validating the connection of the NUD 212 upon receipt of data packets could as well take place in the access node 220. They will also realize that a data packet originating from the SP 404 and intended for delivery towards the NUD 212 could also be validated in the same or in an equivalent manner, by the access node 220 or by the access edge node 260.

Since the service agents and service bindings are created, managed and hosted in the access edge node, reference is now made concurrently to FIGS. 2 and 5, where FIG. 5 is a schematic representation of an access edge node in accordance with the teachings of the present invention. To be able to perform the tasks of creation, management and hosting of the service agents and service bindings while ensuring that service is provided to legitimate users, the access edge node is composed of multiple elements. Because of its location in the access domain 215, the access edge node includes an input output unit including an access domain input/output unit 510 for communicating with the access network 230 of the access domain 215 and with access nodes 220. It is also the access domain input/output unit 510 that receives the service request messages 520. The input/output unit of the access edge node 260 also includes a network/application service provider domains input/output unit 530 for communicating with the network service providers 140 and application service providers 150 over the regional network 235. Furthermore, the access edge node 260 includes a service agent unit 540, a controlling unit 550, and an authentication unit 570.

The service agent unit 540 is composed of a service agents management and control unit 542 and a service bindings hosting unit 544. The service agent unit 540 keeps existing information of service agents 270 in the service agents management and control unit 542. The service agents management and control unit 542 in turn is responsible for the creation and management of the service bindings 546. For doing so, the service agents management and control unit 542 determines when new service bindings 546 are required or can be removed, and proceeds with the creation/removal of service bindings 546. The service agents management and control unit 542 is also responsible for the adding/removal of user devices to existing service bindings. Furthermore, the service agents management and control unit 542 is responsible for ensuring synchronicity of service bindings 546 related information with access nodes with which it is interacting.

Reference to FIG. 6a, which represents an exemplary tabular representation of the content of the service agents management and control unit 542, is now concurrently made with FIG. 5. Each of the rows of FIG. 6a, at the exception of the first row, which is a header row, represents exemplary content of some of the service agents 270 managed and controlled by the service agents management and control unit 542. Each of the columns of FIG. 6a corresponds to specific information, maintained by the service agents management and control unit 542, for each of the service agents 270. The first column represents an identification of the service agent 270. That identification is typically a number or a service agent identifier corresponding to the service agent. In accordance to a preferred embodiment of the invention, each service agent in the access edge node has a unique service agent identifier, and corresponds to one specific service provider domain 140 or 150. The second column refers to an identification of a specific service provider domain 140 or 150 for the corresponding service agent. The third column identifies a service type, the service type possibly being a broad type covering several specific kinds of services. The fourth column identifies transport parameters defining the preferred or necessary Quality of Service (QoS) required for properly transporting data traffic for that service provider domain and the related service type. Exemplary criteria for QoS may include delay, bit error rate, bandwidth, priority, and preferred protocol. It should be noted that in cases where one service provider domain 140 or 150 offers multiple services, each of the services may preferably be associated with a distinct service agent comprising a different set of transport parameters and a distinct VLAN, so as to differentiate between the various services offered by the service provider domain 140 or 150. The fifth column comprises a list of nomadic user domains 212 that have been added to the VLAN corresponding to the service provider domain 140 or 150. In addition to this content, the service agents management and control unit 542 includes sufficient logical software and hardware to create additional service agents and remove unnecessary service agents. It should be noted as well that even though the content of the service agents management and control unit 542 has been represented in FIG. 6a in the form of a table, such content is not limited thereto. The service agents management and control unit may be composed of a relational database, hard coded components, microprocessors, programming library, etc. . .

Reference is now made to FIG. 6b, which represents an exemplary tabular representation of the content of the service bindings hosting unit 544, concurrently with FIG. 5. Each of the rows of FIG. 6b, at the exception of the header row, represents exemplary content of some of the service bindings 546 hosted in the service bindings hosting unit 544. Each of the columns of FIG. 6b corresponds to specific information, hosted in the service bindings hosting unit 544, for each of the service bindings 546. The first column represents an identification of a corresponding service agent, by using for example the service agent identifier of the service agent. The second column identifies the transport parameters specifying the QoS for the service type offered by the service provider, as described in relation with FIG. 6a. The third column contains the nomadic user domain identity, which has been authenticated prior to the creation of the service binding 546. The service binding 546, because it comprises the authenticated nomadic user domain identity, in turn is an authenticated service binding. Hence, each service binding 546 binds together one of the service agents, one of the nomadic user domains 212 and one of the access nodes 220 for providing data traffic between one nomadic user domain 212 and one service provider domain 140 or 150. When further data, signals or messages arrive at the access edge node 260, initiated from the nomadic user domain 212, an identity comprised therein may be compared with the nomadic user domain identity stored in the authenticated service binding 546, for validation purposes. It should be noted that even though the content of the service bindings hosting unit 544 has been represented in FIG. 6b in the form of a table, such content is not limited thereto. The service bindings hosting unit 544 may be composed of a relational database, hard coded components, microprocessors, programming library, etc. . .

Returning now to the description of FIG. 5, the controlling unit 550 of the access edge node is responsible for determining, upon receipt of the service request message 520, whether the request comes from a legitimate user and whether it corresponds to one of the service agents. For doing so, the controlling unit 550 first consults the authentication unit 570. In one embodiment, the authentication unit 570 may contain information and necessary algorithm enabling it to validate the authenticity of a nomadic user domain identity comprised in the service request message 520. Alternatively, the authentication unit 570 may forward the nomadic user domain identity to the network/application service provider domains input/output unit 530, requesting sending of a message towards a subscription database capable 402 of authenticating user identities, in which case the network/application service provider domains input/output unit 530 receives a response from the subscription database 402 and forwards it to the authentication unit 570. The authentication unit 570 informs the controlling unit 550 of the validation result. The controlling unit 550 drops the service request message 520 if the authentication unit 570 indicates that the nomadic user domain identity is found invalid. The controlling unit 550 then consults the service agents management and control unit 542 to determine whether one of the service agents 270 corresponds to the requested service type, if included, and to the service provider domain identified in the service request message 520. In the event that one of the service agents 270 corresponds thereto, the controlling unit 550 instructs the service agents management and control unit 542 to add the nomadic user domain identity to the VLAN of the service agent 270 and to create a service binding 546 for the received service request message 520. The creation of a service binding 546 for the received service request message 520 includes adding an entry in the service bindings hosting unit 544, in which:
the service agent ID (first column) corresponds to the service agent identifier for the service agent 270 corresponding to the requested service provider domain 140 or 150;
the transport parameters are those found in the corresponding service agent identifier; and
the nomadic user domain identity is the authenticated identity received along with the service request message 520.

Then, the controlling unit 550 informs the access node serving the nomadic user domain identified in the service request message, through a service binding related message 590 sent by the access domain input/output unit 510, of the creation of the service binding 546. In the event that a service binding already exists for the service request message 520, the controlling unit 550 informs the serving access node of the existing service binding through a service binding related message 590. Thereafter, when a data packet arrives at the access edge node 260 through one of the access domain input/output unit 510 or the network/application service provider domains input/output unit 530, the data packet being exchanged between the nomadic user domain 212 and the service provider domain 140 or 150, the controlling unit 550 validates the data packet by verifying that the service binding 546 for the nomadic user domain 212 is present in the service binding hosting unit 544, indicating that the nomadic user domain 212 is connected to the access edge node 260. The controlling unit drops the data packet in the event that the service binding unit 544 has no service binding 546 for the nomadic user domain.

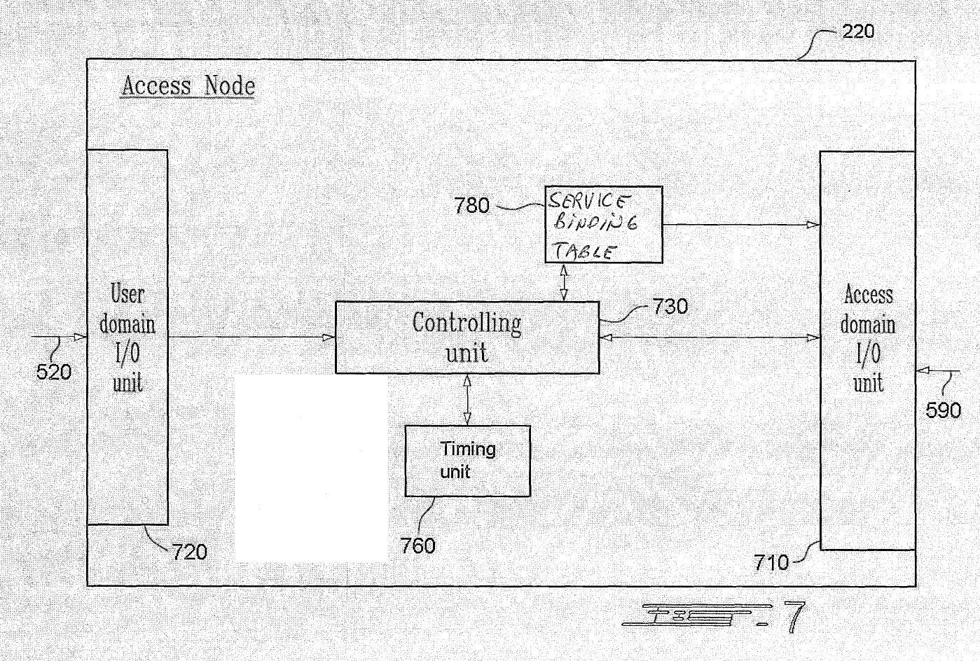

Reference is now made to FIG. 7, which is a schematic representation of one of the access nodes in accordance with the teachings of the present invention. Because of its location in the access domain 215, the access node 220 includes an input/output device comprising an access domain input/output unit 710 for communicating with the access network 230 of the access domain 215 and with the access edge node 260. The input/output device also includes a user domains input/output unit 720 for communicating with user domains 110 including the nomadic user domains 212. A type of messages received at the access domain input/output unit 710 is the service binding related message 590. The service binding related messages 590 are generated by the access edge node 260, and sent over the access network 130.

The access node 220 is capable of receiving and handling multiple service binding related messages 590. The service binding related messages 590 are received at the access node 220 from the access network 130, through the access domain input/output unit 710. Upon receipt of a service binding related message 590, the access domain input/output unit 710 forwards the received service binding related message 590 to a controlling unit 730. The controlling unit 730 extracts the content of the service binding related message 590, and determines whether there are actions to be taken. An example of service binding related message 590 is the information about the creation of a new service binding. As previously described, when the access edge node 260 determines that a new service binding is required, it proceeds with its creation and informs the access node serving the requesting nomadic user domain of the creation of the service binding. The service binding related message 590 sent from the access edge node 260 to the access node 220 contains information on the created service binding. The information contained in the service binding related message 590 must then be incorporated into a service binding table 780 of the access node 220.

One of the various responsibilities of the service binding table 780 is the hosting of service bindings related information. Service bindings related information contains specific service binding information in the form of service agent identity, transport parameters, and authenticated nomadic user domain identity.

The controlling unit 730 and the service binding table 780 are responsible, within the access node 220, to authenticate the user domain 110 or nomadic user domain 212. To do this, whenever an authenticated service binding exists, the controlling unit 730 receives periodic time out signals from a timing unit 760 and, responsive to the time out signals, instructs the user domain input/output unit 720 to send requests for identification of the user domain 110 or nomadic user domain 212. Hence the nomadic user domain 212 is requested to periodically re-identify itself to the access node 220. Where the user domain 110 is a fixed domain, it does not reply to the identification requests. The access node 220 then uses any well-known means, for example verification of which access port the user domain 110 is connected to against internal configuration data of the access node 220, to verify that the user domain is legitimate. On the other hand, a nomadic user domain 212 replies with its identity. This identity is received at the user domain input/output unit 720 and transferred therefrom to the controlling unit 730. The received identity is compared with the authenticated nomadic user identity stored in the service binding table 780. This enables the access node 220 to validate that it is in communication with the proper nomadic user domain. This periodic validation result enables the controlling unit 730 to set a user domain connection status stored in the service binding table 780 and refreshed at regular intervals.

The access node 220 further handles incoming data traffic originating from/destined to nomadic user domains to which it provides access service to the access network 130. Data traffic received at the access node 220 by either the nomadic user domain input/output unit 720 or the access domain input/output unit 710 is forwarded to the controlling unit 730. The controlling unit 730 interacts with the service binding table 780. Upon receipt of downstream data traffic for a given nomadic user domain at the access domain input/output unit 710, the controlling unit 730 consults the service binding table 780 to verify that it is in communication with that given nomadic user domain by use of the latest user domain connection status. Upon receipt of upstream data traffic from the given nomadic user domain at the user domain input/output unit 720, the controlling unit 730 also verifies the corresponding user domain connection status stored in the service binding table 780 prior to processing further the data traffic. The present invention thus allows to seamlessly and securely carry data traffic over the access domain from the nomadic user domain point of view.

Although several preferred embodiments of the method and nodes of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. In an access domain carrying data traffic between nomadic user domains and service provider domains, an access edge node for authenticating nomadic user domains upon access to service provider domains, the access edge node comprising:
a service agent unit comprising one or more service agents, each of the one or more service agents comprising a service provider domain identity and transport parameters;
a service bindings unit comprising service bindings, each of the service bindings including the identity and the transport parameters of one of the service agents and further including an identity of a nomadic user domain;
an input/output unit for communicating with the service provider domains, with the access domain and with access nodes providing the nomadic user domains access to the access domain, the input/output unit sending to the access nodes serving bindings information, the input/output unit further receiving service request messages, each service request message comprising an identity of a selected service provider domain and an identity of a given nomadic user domain;
an authentication unit for determining, upon receipt of a service request message whether the identity of the given nomadic user domain comprised therein is valid; and
a controlling unit for determining, upon receipt of the service request message comprising the valid identity of the nomadic user domain, whether one of the service agents corresponds to the selected service provider domain and, if so, creating an authenticated service binding in the service bindings unit and ordering the input/output unit to inform an access node serving the given nomadic user domain of the authenticated service binding, the controlling unit further applying transport parameters of the authenticated service binding for transporting data traffic between the given nomadic user domain and the selected service provider domain.

2. An access edge node in accordance with claim 1, wherein:
each of the service agents further identifies a Virtual Local Area Network (VLAN) extending between the access edge node and the access nodes; and
the controlling unit, upon creating the authenticated service binding, instructs the service agent unit to add the given nomadic user domain to the VLAN identified in the service agent corresponding to the selected service provider domain.

3. An access edge node in accordance with claim 2, wherein quality of service for nomadic user domains comprised in the VLAN is guaranteed by the transport parameters comprised in the service agent corresponding to the VLAN.

4. An access edge node in accordance with claim 1, wherein:
each service request message further comprises a requested service type; and
the service agent unit comprises a distinct service agent for each service type offered by each service provider domain.

5. An access edge node in accordance with claim 1, wherein the controlling unit further verifies, upon receiving a data packet at the input/output unit, that the service binding corresponding to the nomadic user domain is present in the service binding unit.

6. An access edge node in accordance with claim 1, wherein:
the controlling unit further requests from the input/output unit sending of the identity of the given nomadic user domain towards a subscription database;
the input/output unit further sends the identity of the given nomadic user domain towards the subscription database and receives from the subscription database an identity verification response;
the authentication unit further determines validity of the identity of the nomadic user domain by use of the identity verification response.

7. A method for authenticating a nomadic user domain upon access to a selected service provider domain over an access domain, the method comprising the steps of:
providing a plurality of service agents in an access edge node, each of the service agents corresponding to a service provider domain, and comprising transport parameters;
receiving at the access edge node a service request message identifying the selected service provider domain and comprising an identity of the nomadic user domain;
authenticating the identity of the nomadic user domain;
determining whether one of the plurality of service agents corresponds to the selected service provider domain;
if the identity of the nomadic user domain is authenticated and one of the plurality of service agents corresponds to the selected service provider domain:
creating at the access edge node an authenticated service binding for the received service request message, the service binding containing an identity of the service agent corresponding to the selected service provider domain, the identity of the nomadic user domain, and transport parameters comprised in the service agent corresponding to the selected service provider domain;
sending a copy of the service binding towards an access node responsible for providing access to the nomadic user domain; and
using the transport parameters of the service binding at the access edge node for transporting data traffic between the identified nomadic user domain and the selected service provider domain.

8. The method of claim 7, wherein the transport parameters of the service binding are further used at the access node for transporting data traffic between the identified nomadic user domain and the selected service provider domain.

9. The method of claim 7, wherein:
the step of providing a plurality of service agents further comprises maintaining a Virtual Local Area Network (VLAN) between the access edge node and access nodes for each of the service provider domains; and
the step of creating a service binding further comprises adding the nomadic user domain to the VLAN corresponding to the selected service provider domain.

10. The method of claim 7, wherein the transport parameters of each of the service agents includes quality of service (QoS) parameters.

11. The method in accordance with claim 7, further comprising the step of:
using the service binding to validate a connection with the nomadic user domain upon receiving a data packet at the access edge node.

12. The method in accordance with claim 7, wherein the step of authenticating the identity of the nomadic user domain further comprises the steps of:
sending from the access edge node towards a subscription database the identity of the nomadic user domain;
receiving from the subscription database an identity verification response; and
ignoring the service request message if the identity verification response indicates that the identity of the nomadic user domain is invalid.

13. In an access domain carrying data traffic between nomadic user domains and service provider domains, an access node for providing nomadic user domains access to the access domain, the access node comprising:
an input/output device for sending requests for identification towards the nomadic user domains, for receiving identities from the nomadic user domains, for forwarding the identities received from the nomadic user domains over the access domain, for receiving service binding information, and for receiving and forwarding data traffic;
a service binding table for storing service binding information for a plurality of service bindings, the information for each service binding including an identification of a corresponding service provider domain, an authenticated identity of a nomadic user domain, and transport parameters, the service binding table further storing for each service binding a user domain connection status;
a timing unit for sending periodic time out signals; and
a controlling unit for:
receiving the periodic time out signals and instructing the input/output device to send the requests for identification,
receiving an identity from a given nomadic user domain from the input/output device and requesting the service binding table to store a user domain connection status in the corresponding service binding,
verifying, upon receipt of data traffic from the given nomadic user domain, the user domain connection status and, if the user domain connection status indicates that the nomadic user domain is connected,
informing the input/output device to forward the received data traffic over the access domain in accordance with the transport parameters of the corresponding service binding.

14. An access node in accordance with claim 13, wherein the controlling unit further determines, upon receipt from the access domain of data traffic for the given nomadic user domain, whether the user domain connection status indicates that the given nomadic user domain is connected and, if so, informs the input/output device to forward the received data traffic towards the nomadic user domain in accordance with the transport parameters of the corresponding service binding.
